(19) United States
(12) Patent Application Publication
(10) Pub. No.: US 2026/0001601 A1
(43) Pub. Date: Jan. 1, 2026

(54) Method for Producing a Motor Vehicle, and Motor Vehicle

(71) Applicant: Bayerische Motoren Werke Aktiengesellschaft, Muenchen (DE)

(72) Inventors: Dominik EXNER, Otterfing (DE); Alexander GRIMM, Karlsfeld (DE); Matthias STANGL, Friedberg (DE)

(21) Appl. No.: 18/880,739

(22) PCT Filed: Nov. 13, 2023
(86) PCT No.: PCT/EP2023/081606

§ 371 Date: Jan. 2, 2025

(30) Foreign Application Priority Data
Nov. 14, 2022 (DE) 10 2022 130 021.8

(51) Int. Cl. B62D 65/04; B62D 27/02; B62D 63/02

(52) U.S. Cl. CPC B62D 65/04; B62D 27/02; B62D 63/025

(57) ABSTRACT

A method for producing a motor vehicle by producing multiple structural modules, wherein each structural module includes at least one structural component of a vehicle body and at least one vehicle component, and assembling the multiple structural modules to form the motor vehicle, whereby the motor vehicle is already provided with a plurality of vehicle components upon completion of the supporting motor vehicle structure, and wherein the structural modules are joined to one another on the structural component side exclusively using cold joining techniques.

### BACKGROUND AND SUMMARY

This disclosure concerns a method for producing a motor vehicle, and a motor vehicle.

A motor vehicle with conventional structure has a corrosion-protected and sealed body which is provided with vehicle components, such as attachments in the interior and exterior, electronic devices, seat belts, seats etc. Furthermore, the complete vehicle has a drive train with drive motor, transmission and axles.

In the conventional production concept for producing a motor vehicle, firstly the vehicle individual components are produced, then the body in white is assembled in the body construction area and subsequently provided with corrosion protection and paint. Final assembly into the complete vehicle takes place on a main assembly line, on which the drive train is joined to the body and the vehicle is finally equipped with the interior and exterior vehicle components.

Major technical changes affect the entire vehicle and the described production chain, and can only be implemented with great effort. Fundamental changes to the vehicle can only be implemented with very high financial cost.

In the context of a volatile market environment, rapid technological progress and ever tighter regulations from legislators, there is a need for an economic production concept for producing vehicles. In a further aspect, the production concept should allow a great flexibility for change with low or reduced costs of change.

In this context, it is an object of the disclosure to indicate a possibility of how the production of a motor vehicle can be improved. In particular, it must be possible to avoid the above-described disadvantages.

A method is disclosed for producing a motor vehicle with the steps:
production of multiple structural modules, wherein each structural module contains at least one structural component of a motor vehicle body and at least one vehicle component, and
assembly of the multiple structural modules to produce the motor vehicle, whereby the motor vehicle is already equipped with a plurality of vehicle components upon completion of the supporting motor vehicle structure,
wherein the structural modules are joined together on the structural component side exclusively using cold joining techniques.

A structural module contains at least one structural component. A structural component plays a structure-defining role in the complete vehicle and for example absorbs forces and/or moments. A structural component may be a front end, a rear end, a vehicle pillar, a side frame, a roof spar, a vehicle roof etc. Also, two or more structural components may be joined into a structural assembly in one structural module. For production of the structural assembly, in principle all known joining methods may be used. A structural assembly may for example have two or more structural components which may be welded, riveted, bolted and/or bonded together. The structural components may for example be metal components, fiber-reinforced plastic components, or composite components which contain both metal and also plastic materials, in some cases fiber-reinforced plastic material. The structural components may be produced e.g. using primary forming processes, deforming processes, additive methods and combinations of these methods, and in particular comprise sheet-metal components, cast components, additively manufactured components or hybrid components with portions of sheet metal, castings and/or additively manufactured components. The structural components or structural assembly may for example be provided with an anticorrosion coating. Preferably, the structural components or structural assemblies/assembly are/is already fully painted.

Furthermore, a structural module contains at least one vehicle component. Vehicle components in the context of this application are components of the vehicle which are not constituents of the actual body shell of a motor vehicle. Such vehicle components are e.g. usually only connected to the vehicle body after completion thereof. For example, the vehicle components are control units, sensors, vehicle interior and/or vehicle exterior trim panels, attachments such as e.g. mirrors, signaling devices such as vehicle lights or horn, vehicle windows, cables etc. One or more vehicle components are mounted on the above-described structural component or structural assembly, whereby the structural module is produced.

To produce the vehicle, multiple structural modules are now joined together. Here, firstly the supporting structure of the entire vehicle is created-similarly to a conventional body-but at the same time the assembly already contains a plurality of vehicle components. In other words, the method eliminates the former usual body frame and replaces this with a plurality of structural modules, which are already pre-assembled with further vehicle components. The supporting structure of the motor vehicle is preferably composed mainly of structural modules, for example more than 70% or more than 80% or more than 90% of the structural components are firstly equipped with further vehicle components and assembled into a structural module. In these cases, individual structural components may remain, which are mounted on the structural modules as individual components or component assemblies, but not as modules.

By the use of the described structural modules, the number of parts and mounting processes on the main assembly line is reduced. This decreases the necessary complexity and length of the main assembly line, and costs can be reduced. Furthermore, the flexibility of production is increased. The influence of the changes to individual structural modules on the entire production process is reduced to those portions of the process in which the respective structural module is produced. Thus changes can be implemented more quickly and better integrated into the existing production process.

On assembly, the structural modules are joined on the structural component side. Here, the structural components or structural assemblies of adjacent structural modules are permanently connected together. According to the disclosure, the joining on the structural component side takes place exclusively using cold joining techniques. “Cold joining techniques” are in particular rivet connections, screw connections and bonded connections. Preferably, the structural modules are inseparably connected together, i.e. the joint connection can only be made by destruction of the joining aid (e.g. rivet or adhesive) or by damaging the structural module. By the exclusive use of cold joining methods for connecting structural modules together, it is possible to apply an anticorrosion coating and paintwork to the structural modules or parts of the structural modules, in particular the structural components, before assembly. It is no longer necessary to firstly produce the vehicle body and then conduct this as a component body through a KTL bath (so referred to as cataphoretic electro-coating) for painting using large equipment and complex processes. Instead, the corresponding equipment can be designed significantly smaller, saving costs and production surface areas. Also, the joining technique on the main assembly line is greatly simplified, reducing the complexity, and the joining equipment can be standardized and used more universally. Thus a further cost reduction is possible.

In one embodiment, the supporting structure of the motor vehicle may be formed exclusively from structural modules, whereby the number of parts to be mounted on the main assembly line is further reduced and the assembly process further simplified.

In a preferred embodiment, the motor vehicle is constructed such that a first structural module serves as a construction platform for all further modules. For example, the construction platform may have connecting faces for further structural modules. If the first structural module is used as a construction platform, this is preferably placed in a defined position on a mounting jig. The mounting jig may in particular be a flexible receiver for different construction platforms. Such a mounting jig may for example be configured as a matrix-hole table which can receive construction platforms flexibly in all three spatial axes (X, Y, Z). Thus the mounting jig can rapidly and flexibly be adapted to construction platforms with different geometric dimensions. The first structural module/construction platform is e.g. aligned and fixed on the mounting jig. The motor vehicle is then assembled starting from the first structural module. Further structural modules are then aligned and joined to the first structural module/construction platform. When the supporting structure is complete, further modules e.g. door modules can be mounted. The relative positioning of the modules to and against one another may be achieved for example by robot-guided gripping systems. The assembly into the complete vehicle progresses further with each structural module/module. Thus, starting from the first structural module/construction platform, the vehicle body grows by further modules. The further construction is oriented to the first structural module/construction platform or the already existing assembly of the construction platform with further structural modules. Thus the assembly process is largely independent of geometry. This allows the universal use of a single mounting jig for a plurality of vehicle variants, whereby assembly is economic with simultaneous flexibility with respect to changes.

If a first structural module is used as a construction platform, the structural modules preferably have component-integrated geometric features, which are configured to allow a precise positioning of the further structural module on the construction platform. The structural modules have for example mounting faces at which they are connected together. The component-integrated geometric features are preferably arranged in these mounting faces. The component-integrated geometric features may for example be configured as mutually corresponding latching or clip connections etc. When two structural modules are brought together, the component-integrated geometric features preferably engage in one another and thus define the precise and correct orientation of the structural modules relative to one another. The component-integrated geometric features may for example be primary-formed, e.g. by casting or injection-moulding processes; deformed, e.g. on the production of formed sheet-metal components; or be formed by mechanical machining of the structural modules, e.g. by milling etc. The use of component-integrated geometric features is also very economic since no separate devices are required for positioning the structural modules.

In an embodiment, with respect to assembly, it is advantageous if an energy-storage module is used as the construction platform/first structural module. An energy-storage module as a vehicle component comprises in particular an energy store, the energy of which is used to drive the motor vehicle. The energy store is preferably configured as a high-voltage battery, but may also be a tank for fuel, e.g. petrol, diesel or hydrogen. The energy store housing, in particular in the case of a high-voltage battery, may perform additional structural tasks in the complete vehicle. Accordingly, an energy-storage module is designed to be particularly stable and is therefore particularly suitable as a starting point for assembly of the structural modules.

It is particularly preferred if the first structural module forms a floor unit of the motor vehicle. The floor unit may for example have a vehicle front end and a vehicle rear end. The floor unit forms the lowest point of the vehicle body and, because of this physical arrangement in the complete vehicle, is particularly suitable for serving as a starting point for construction of the vehicle. This is especially the case if the floor unit is simultaneously configured as an energy-storage module and therefore made particularly heavy. The floor unit carries the further body constituents and is thus particularly suitable, as a construction platform, for providing the basis for construction of the complete vehicle. The construction of different models with the same floor unit is thus possible particularly simply. Model variations can easily and economically be assembled on the same main assembly line.

In an embodiment, a front bulkhead module is used as a further structural module. The front bulkhead module preferably contains the front bulkhead of the vehicle and components of the dashboard, such as e.g. a dashboard support, a dashboard trim, an air-conditioning system etc.

Furthermore, in an embodiment, it may be provided that a side frame module is used as a further structural module. The side frame module has a side frame which for example is formed from one or more sheet-metal components. The side frame preferably extends from an A-pillar via a B-pillar towards the rear to a C-pillar, or in motor vehicles of the estate design, as far as a D-pillar. Preferably, openings for side vehicle doors are provided in the side frame. In an embodiment, the side frame may furthermore have a deformation element, in particular in the region below the openings for the vehicle doors, which is configured to cooperate with the floor unit to improve the stability and energy dissipation in the case of a side impact, for the protection of the high-voltage battery. For example, one or more internal equipment components of the vehicle, such as e.g. a vehicle safety belt, interior trim components, locks etc., are attached to the side frame.

For assembly of the structural modules, it is particularly advantageous if, in an embodiment, the structural modules are mechanically pre-fixed and bonded with further structural modules. The mechanical pre-fixing may be achieved for example by clip or screw connections. The pre-fixing here performs only the task of fixing the structural modules in predefined positions relative to one another until the adhesive has finally hardened. Because of the mechanical pre-fixing, further mounting activities on the vehicle can take place already before the adhesive has completely hardened. Thus successive mounting steps can take place without great idle time. The use of bonding as a joining method also allows greater flexibility with respect to the choice and/or combination of materials of the individual structural modules. Also, the joining connection may simultaneously be used as a seal, whereby the number of working steps can be reduced.

As it is now not purely structural components which are assembled into the vehicle body, but pre-assembled structural modules are used, a smaller number of parts is possible on the main assembly line, and mounting on the main assembly line is greatly simplified. In this respect, it is particularly advantageous if, in one embodiment, the vehicle opening panels and/or vehicle doors are attached to the vehicle body as pre-assembled modules. For example, when mounted on the body, the vehicle doors may already be equipped with windows, window lifters, closing systems and a door inner trim panel. Also, further components, such as e.g. sound insulation, a window and/or an interior trim panel, may be pre-mounted on the vehicle opening panels.

Furthermore, a motor vehicle is indicated, with a construction which is composed of multiple structural modules, wherein each structural module contains at least one structural component of a vehicle body and at least one vehicle component. The structural modules are joined together on the structural component side exclusively using cold joining techniques.

The motor vehicle may in particular be produced using the above-described method. Here, the vehicle achieves the same advantages and technical effects as have already been described above with reference to the method.

Features and details which are described in connection with the method also apply in connection with the motor vehicle according to the disclosure, and vice versa, so that with respect to the disclosure, references to the individual disclosure aspects are always reciprocal.

Further advantages, features and details of the disclosure arise from the following description, which describes in detail exemplary embodiments of the disclosure with reference to the drawings. The features cited in the claims and in the description may be essential to the disclosure both alone or in any combination. Where the term “can” or “may” is used in this application, it refers to both the technical possibility and also to the actual technical implementation.

### BRIEF DESCRIPTION OF THE DRAWINGS

Exemplary embodiments are explained below with reference to the appended drawings.

FIG. 1 is a flow diagram of an exemplary method for producing a motor vehicle; and,

FIG. 2 is an exemplary mounting jig for use in the method.

### DETAILED DESCRIPTION OF THE DRAWINGS

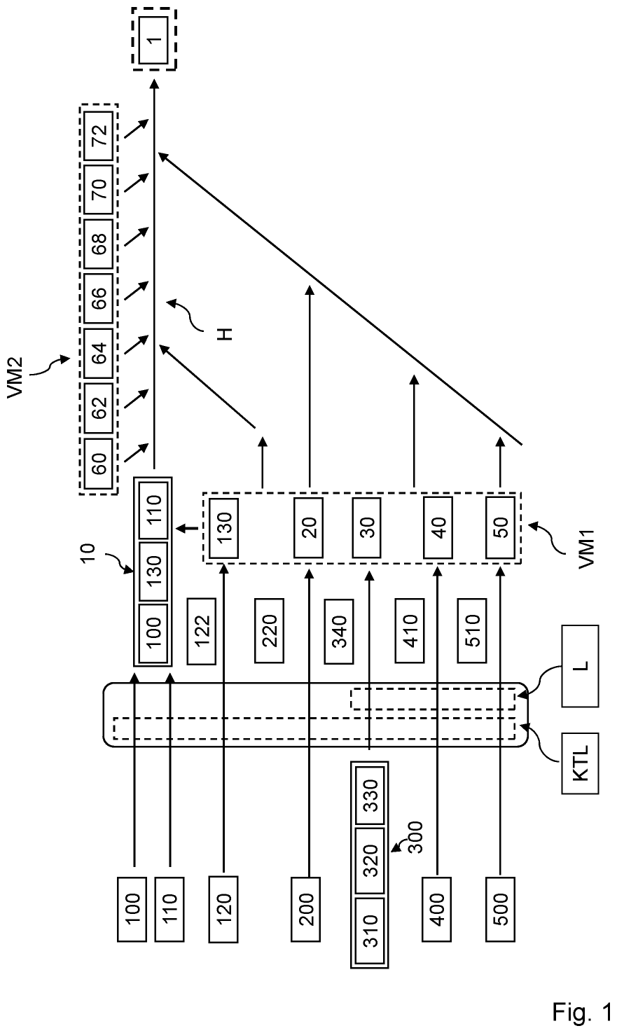

FIG. 1 shows a method for producing a motor vehicle 1. Before assembly into the complete vehicle 1 on a main assembly line H, firstly structural modules 10, 20, 30 are produced. Each structural module 10, 20, 30 has at least one structural component 100, 110, 120, 200, 310, 320, 330, and at least one vehicle component 122, 220, 340. FIG. 1 shows exemplary structural components, e.g. a front end 100, a rear end 110, a storage housing 120 for a high-voltage battery, and a front bulkhead 200. A further structural component 300 in the form of a side frame is produced as a structural assembly by joining together three side frame components 310, 320, 330. Furthermore, further vehicle components, such as e.g. doors 400 and opening panels 500, are produced. If necessary or desired, the vehicle components are subjected to an anticorrosion treatment KTL and painting L. In a first pre-mounting step VM1, the structural components are pre-assembled together with at least one vehicle component 122, 220, 340 into a structural module 10, 20, 30. For example, the storage housing 120 is pre-assembled together with the further storage components 122 into an energy-storage module 130; the front bulkhead 200 is pre-assembled with components of the dashboard 220 into a front bulkhead module 20; the side frame 300 is pre-assembled with a trim part 340 into a side frame module 30. Further structural modules, not shown here, may be provided. In the first pre-mounting step VM1, the doors 400 are furthermore pre-assembled with door components 410 into a door module 40, and the vehicle opening panels 500 are pre-assembled with further components 510 into opening panel modules 50. Then a front end 100 and a rear end 110 are mounted on the energy-storage module 130 so as to create a structural module 10 in the form of a floor unit. This floor unit preferably serves as a construction platform for the following assembly of the complete vehicle 1. Alternatively, the energy-storage module 130 may already serve as a construction platform; in this case, the front end 100 and rear end 110, as structural components of a further structural module (not shown), are mounted on the energy-storage module 130.

Starting from the construction platform in the form of the structural module 10, the complete vehicle assembly now takes place on the main assembly line H. For this, the structural module 10 is preferably positioned on a matrix-hole table with flexible receiver (XYZ) as a basis for all remaining modules. The further structural modules 20, 30 and the door and opening panel modules 40, 50 are then mounted, whereby the complete vehicle 1 grows from module to module. The modules are preferably positioned by a flexible gripper with movable end effectors, which are flexibly adaptable to the respective handling task. The flexible grippers may for example be robot-guided.

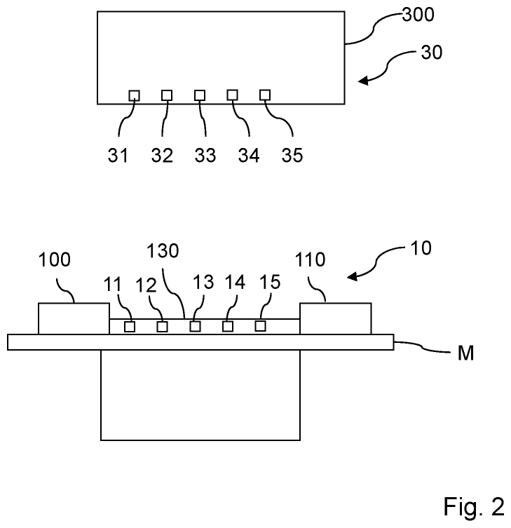

The structural modules 10, 20, 30 are joined together on the structural component side exclusively by way of cold joining techniques. Preferably, the structural modules 10, 20, 30 are bonded together, wherein they may be additionally pre-fixed for example by screws or clip connections. Component-integrated geometric features, which allow highly precise positioning, may be provided on the structural components 100, 110, 120, 200, 300. FIG. 2 shows the first structural module 10 which is positioned and fixed on a mounting jig M. The first structural module 10 has multiple component-integrated geometric features 11-15, which for example are arranged in the storage housing 120 of the energy-storage module 130. For mounting, a further structural module 30 in the form of a side wall module is arranged and precisely positioned on the first structural module 10 by way of corresponding component-integrated geometric features 31-35, and can be joined thereto.

To finish the complete vehicle 1, further vehicle components 60, 62, 64, 68, 70, 72 are mounted, unless they have already been installed in modules. For example, these are lines, axles, wiring looms, carpets, seats, a center console and a roof. These vehicle components may be produced for example in a further pre-mounting step VM2 and delivered to the main assembly line H.

### LIST OF REFERENCE SIGNS

1 Complete vehicle
10, 20, 30 Structural module
11-15, 31-35 Component-integrated geometric features
40 Door module
50 Opening panel module
60, 62, 64, 68, 70, 72 Vehicle components
100, 110, 120, 200, 310, 320, 330 Structural component
122, 220, 340 Vehicle component
130 Energy-storage module
300 Structural assembly
400 Doors
500 Opening panels
H Main assembly line
KTL Anticorrosion treatment
L Painting
M Mounting jig
VM1, VM2 Pre-mounting step

1.-11. (canceled)

12. A method for producing a motor vehicle, comprising:
producing multiple structural modules, wherein each structural module contains at least one structural component of a vehicle body and at least one vehicle component, and
assembling the multiple structural modules to produce the motor vehicle,
whereby the motor vehicle is already equipped with a plurality of vehicle components upon completion of the supporting motor vehicle structure, and
wherein the structural modules are joined together on the structural component side exclusively using cold joining techniques.

13. The method according to claim 12, wherein
the supporting structure of the motor vehicle is formed exclusively from structural modules.

14. The method according to claim 12, wherein
the motor vehicle is constructed such that a first structural module serves as a construction platform for all further modules.

15. The method according to claim 12, wherein
the structural modules have component-integrated geometric features which are configured to allow a precise positioning of the structural modules relative to one another.

16. The method according to claim 14, wherein
the first structural module forms an energy-storage module of the vehicle.

17. The method according to claim 14, wherein the first structural module forms a floor unit of the vehicle.

18. The method according to claim 14, wherein a front bulkhead module is used as a further structural module.

19. The method according to claim 14, wherein a side frame module is used as a further structural module.

20. The method according to claim 12, wherein
the structural modules are mechanically pre-fixed and bonded for connection to further structural modules.

21. The method according to claim 12, wherein the vehicle opening panels and/or vehicle doors are also fitted as pre-assembled modules.

22. A motor vehicle, produced using a method according to claim 12, comprising:
a construction which is composed of multiple structural modules, wherein each structural module contains at least one structural component of a vehicle body and at least one vehicle component, and
the structural modules are joined together on the structural component side exclusively using cold joining techniques.
